(19) United States
(12) Patent Application Publication
(10) Pub. No.: US 2025/0260151 A1
(43) Pub. Date: Aug. 14, 2025

(54) ANTENNA SPACER

(71) Applicant: Advanced Navigation and Positioning Corp., Hood River, OR (US)

(72) Inventors: Talia Emma Toland, Hood River, OR (US); Connor Michael Webb, Hood River, OR (US); Frank Alton Gray, Medford, OR (US)

(21) Appl. No.: 18/438,132

(22) Filed: Feb. 9, 2024

(51) Int. Cl. H01Q 1/12; H01Q 1/24; H01Q 9/30

(52) U.S. Cl. CPC H01Q 1/1235; H01Q 9/30; H01Q 1/246

(57) ABSTRACT

Assemblies, apparatuses, and methods are presented herein for coupling elements of an antenna assembly. A coupling apparatus for coupling antennas of an antenna assembly includes a spacer. A first end of the spacer is configured to interface with a first antenna. A second end of the spacer is configured to interface with a second antenna. An internal passageway extends from an end opening in the first end. The internal passageway also extends from a side opening between the first end and the second end.

### INTRODUCTION

The present disclosure is directed to assemblies, apparatuses, and methods for coupling elements of an antenna assembly, and more particularly, to coupling antennas to each other and to a base plate for rapid assembly of an antenna assembly that is of a manageable weight in a remote environment in order to facilitate one or more of aircraft guidance or ground to air communication.

### SUMMARY

Transponder-based aircraft landing systems generally facilitate guidance of aircraft during approach and landing with respect to an airport or other landing field. Typical transponder-based systems include electronics, antennas, and other equipment for sending and receiving signals to incoming aircraft to facilitate aircraft guidance. While these landing systems may be permanently installed at a landing field, deployable instrument landing systems (ILSs) have also been developed that can be deployed to a remote airfield and/or taken down from the airfield relatively quickly, e.g., for defense and emergency response applications. Known deployable ILSs can provide multiple essential functions for air operations at remote or temporary airfields including precision approach guidance, secondary surveillance for tracking and separation (ATC), and precision approach radar for ground-controlled approaches in military and/or emergency applications, thus providing a complete ATC solution.

Existing deployable ILSs generally include electronics, multiple antennas, power supply, and other components, and as a result are complex and difficult to transport. Existing deployable ILSs also generally require delivery to the remote airfield in multiple large, heavy payloads. Additionally, deployment of these ILSs typically requires at least approximately 18 man-hours of installation time (e.g., 6 hours by 3 personnel) once the equipment is delivered to the location for the remote airfield. As a result, delivery and deployment of known deployable ILSs to a remote airfield requires multiple deliveries or delivery vehicles, and setup of the deployable ILS is time-intensive upon delivery. Accordingly, there is a need for an antenna tower assembly that can be rapidly transported to a remote area and rapidly assembled with minimal personnel.

In some embodiments, this disclosure is directed to a coupling apparatus comprising a spacer. The spacer comprises a first end configured to interface with a first antenna and a second end configured to interface with a second antenna. An internal passageway is also part of the spacer and extends from an end opening in the first end as well as from a side opening between the first end and the second end.

The coupling apparatus, and additional elements described herein, solve the problems of other approaches described above. In particular, this approach does not rely on bulky or heavy components to set up an antenna assembly in a remote location (e.g., distant from known or heavily populated residential areas) for any or all of the aforementioned uses. Thus, the spacer and other elements of this disclosure provide opportunity to rapidly establish an airfield for rapid grounding of aircraft or rapidly establish ground to air communication without a plurality of personnel being available in the remote location. Additionally, the approaches, assemblies, and apparatuses of this disclosure may not require multiple vehicles for delivery of components, and the various embodiments of this disclosure may not require complex or long in duration assembly processes. By reducing the complexity of the assemblies required for establishing a remote airfield or remote ground to air communication, as opposed to relying on intricate or more permanent structure, the various embodiments of this disclosure provide means for rapid deployment, assembly, and establishment of antennas for various uses in a variety of remote environments.

In some embodiments, an end cap is fixedly attached to the second end of the spacer, wherein the second end of the spacer is configured to interface with the second antenna via the end cap. The spacer comprises a flange configured to be fixedly attached to the end cap and the end cap comprises a plurality of evenly spaced eyelets that extend away from a radially outer surface of the end cap. In some embodiments, an accessory platform (e.g., for mounting a sensor or other component) is arranged between the spacer and the end cap.

In some embodiments, at least one of the first end or the second end comprises at least one feature for fixedly attaching the spacer to either the first antenna or the second antenna. Additionally, or alternatively, the side opening is a first side opening and the spacer further comprises a second side opening arranged opposite of the first side opening.

In some embodiments, the first end comprises a flange configured to interface with one or more pull latches. Additionally, or alternatively, when the first antenna is coupled to the first end, a cable that a comprises a connector passes through the internal passageway from the side opening and towards a complementary connector on a surface of the first antenna. The connector may then be coupled to the complementary connector.

In some embodiments, the disclosure is directed to an antenna assembly. The antenna assembly includes a spacer having a first ring shaped end surface and an internal passageway extending between an opening in the first ring shaped end surface and a side opening between the first ring shaped end surface and a second ring shaped end surface. A first antenna segment is fixedly attached to the first ring shaped surface of the spacer, wherein a cable comprising a connector passes through the internal passageway from the side opening and towards a complementary connector on a surface of the first antenna segment. A second antenna segment is coupled to the second ring shaped end surface of the spacer.

In some embodiments, the assembly also includes an antenna base comprising a base spacer pivotably attached to a base plate. The antenna base comprises a hinge assembly defining a hinge axis for rotating the base spacer. Additionally, or alternatively, a pair of slots are coupled to the base spacer. Each of the pair of slots extends radially outward from the hinge axis.

In some embodiments, the assembly also incorporates at least one pull latch that fixedly attaches an end of the second antenna segment to a top surface of the base spacer. Additionally, or alternatively, a flange of the base spacer comprises at least one alignment feature for locating the at least one pull latch before clamping the end of the second antenna segment to the top surface of the base spacer via the at least one pull latch. The at least one pull latch may include a plurality of pull latches. Additionally, or alternatively, a flange comprises the top surface of the base spacer. Each pull latch of the plurality of pull latches may be fixedly attached to the flange. Each pull latch of the plurality of pull latches may interface with a respective alignment feature of a flange of an antenna segment.

In some embodiments, the assembly additionally has a clamp assembly. The clamp assembly incorporates a hinge rotatably coupling a first arched arm to a second arched arm. Each of the first arched arm and second arched arm comprise a channel that is configured to accommodate a flange of the spacer and a flange of one of the first antenna segment and the second antenna segment. The channel comprises a width that narrows towards a bottom of the channel. An adjustable handle may be arranged on the clamp assembly to increase a clamping force between an end of the first arched arm and an end of the second arched arm.

In some embodiments, the disclosure is directed to a method of assembling an antenna assembly. A bottom end of a first antenna segment is secured to a base spacer of a base plate. A top end of the first antenna segment is coupled to a first end of a spacer. A bottom end of a second antenna segment is fixedly attached to a second end of the spacer with at least one pull latch.

In some embodiments, the method includes feeding a wire through a side opening of the spacer and into a passageway of the spacer. A connector of the wire is secured to a complementary connector on an exposed bottom surface of the second antenna segment. A first end of at least one guy wire is secured to at least one guy wire eyelet of a coupling apparatus comprising the spacer. A distal second end of the at least one guy wire is fixedly attached to a grounded anchoring apparatus.

### BRIEF DESCRIPTIONS OF THE DRAWINGS

The above and other objects and advantages of the disclosure may be apparent upon consideration of the following detailed description, taken in conjunction with the accompanying drawings, in which:

FIG. 1 depicts an antenna assembly, in accordance with some embodiments of the disclosure;

FIG. 2A depicts an antenna subassembly where ends of antennas are coupled to opposite ends of a spacer, in accordance with some embodiments of the disclosure;

FIG. 2B depicts an antenna subassembly incorporating the multiple of the antenna subassembly of FIG. 2A, in accordance with some embodiments of the disclosure;

FIG. 3A depicts a coupling apparatus, in accordance with some embodiments of the disclosure;

FIG. 3B depicts a cross sectional view of the coupling apparatus of FIG. 3A, in accordance with some embodiments of the disclosure;

FIG. 4A depicts a top view of an end cap of a coupling apparatus, in accordance with some embodiments of the disclosure;

FIG. 4B depicts a side cross sectional view of the coupling apparatus of FIG. 4A, in accordance with some embodiments of the disclosure;

FIG. 4C depicts a side cross sectional view of an eyelet of the coupling apparatus of FIGS. 4A and 4B, in accordance with some embodiments of the disclosure;

FIG. 5 depicts a spacer between a pair of antennas with an accessory platform, in accordance with some embodiments of the disclosure;

FIG. 6A depicts an antenna base interfacing with a gin pole as part of an antenna subassembly, in accordance with some embodiments of the disclosure;

FIG. 6B depicts a base plate spacer of the antenna base of FIG. 6A pivoting about a hinge axis as part of antenna subassembly 600B, in accordance with some embodiments of the disclosure;

FIG. 6C depicts the base plate of FIGS. 6A and 6B coupled at a bottom of an antenna subassembly, in accordance with some embodiments of the disclosure;

FIG. 7A depicts a cross sectional side view of a clamp assembly that interfaces with a spacer and an antenna, in accordance with some embodiments of the disclosure;

FIG. 7B depicts a perspective view of the clamp assembly of FIG. 7A interfacing with a base plate spacer and an antenna, in accordance with some embodiments of the disclosure;

FIG. 8 depicts a manner of erecting an antenna assembly, in accordance with some embodiments of the disclosure;

FIG. 9A depicts a first perspective view of routing a cable into a spacer towards an antenna coupled to the spacer, in accordance with some embodiments of the disclosure;

FIG. 9B depicts a second perspective view of routing a cable into a spacer towards an antenna coupled to the spacer, in accordance with some embodiments of the disclosure; and

FIG. 10 is a flow chart representing an illustrative process for assembling an antenna assembly, in accordance with some embodiments of the disclosure.

### DETAILED DESCRIPTION

Apparatuses, assemblies, and methods are provided herein for coupling elements of an antenna assembly.

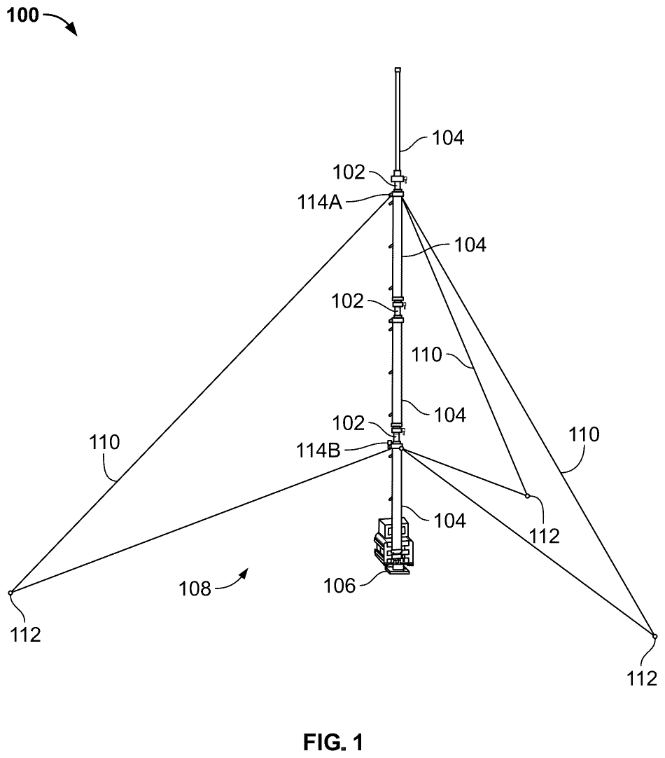

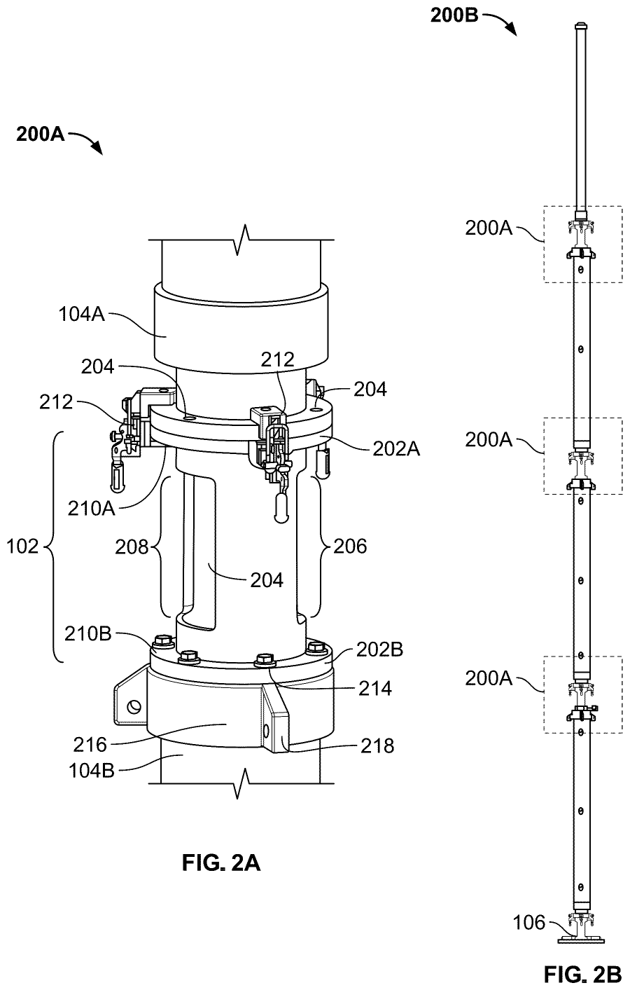

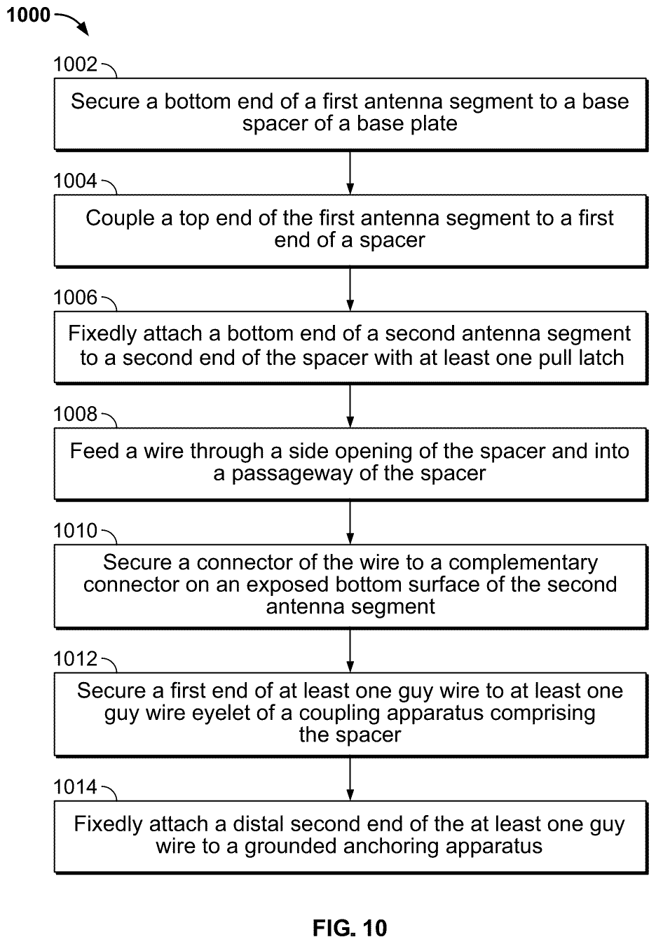

FIG. 1 depicts antenna assembly 100, in accordance with some embodiments of the disclosure. Antenna assembly 100 may include, or incorporate, any or all of the elements showed in, or described in reference to FIGS. 2A-9B. Additionally, or alternatively, antenna assembly 100 may be assembled using any, or all, of the elements of process 1000 of FIG. 10.

Antenna assembly 100 is shown in an erected configuration after being assembled (e.g., via process 1000 of FIG. 10). As shown in FIG. 1, antenna assembly 100 includes at least one of spacer 102 between a pair of antenna segments 104. In some embodiments, each of antenna segments 104 may be considered an individual antenna. Antenna assembly 100 includes three of spacer 102 and has antenna base 106 that affixes antenna assembly 100 to surface 108. In some embodiments antenna base 106 comprises a base plate spacer pivotably coupled, or pivotably attached, by a hinge assembly to a base plate that gets affixed to surface 108. Guy wires 110 extend from surface mounts 112 to guy wire eyelets 114A and 114b. As shown in FIG. 1, a plurality of guy wires 110 (e.g., two or more) may be utilized to erect and secure antenna assembly 100. Surface mounts 112 are fixedly attached to surface 108. Surface mounts 112 may be configured to remain secured to surface 108 when exposed to one or more of vertical loads, lateral loads, or combinations thereof, depending on forces caused by one or more of wind blowing against antenna assembly 100 or the collective weight of each portion of antenna assembly 100.

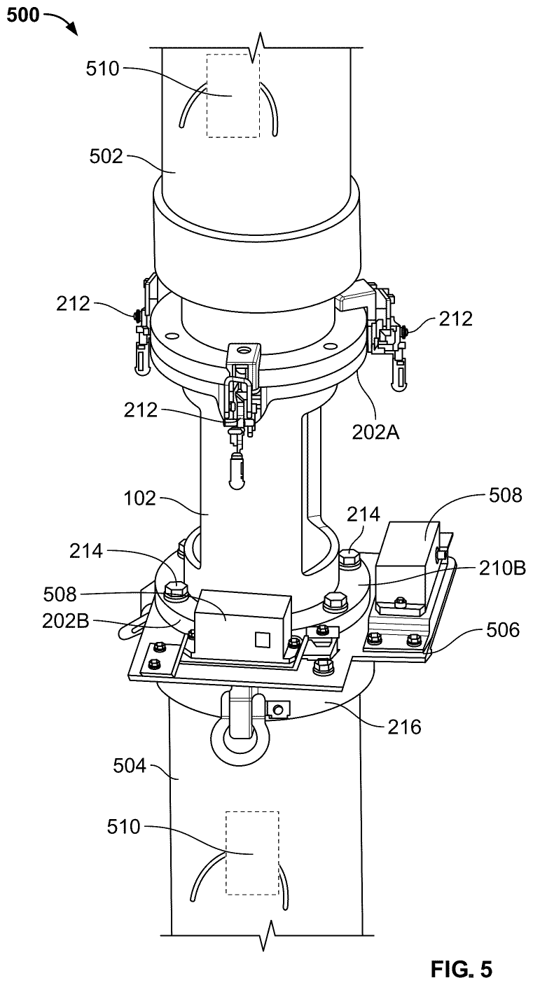

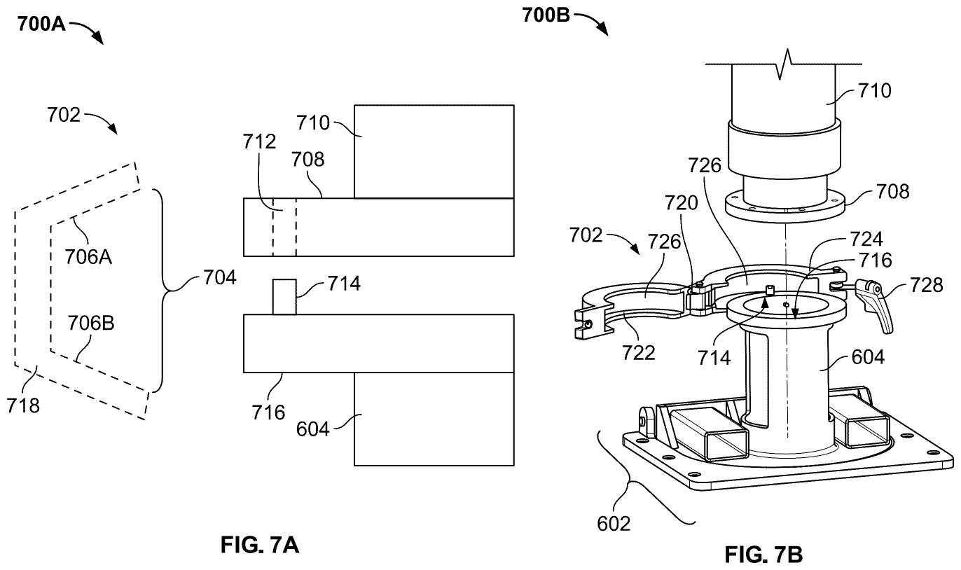

Each of spacer 102 has a first ring shaped end surface and an internal passageway extending between an opening in the first ring shaped end surface and a side opening between the first ring shaped end surface and a second ring shaped end surface (e.g., as shown in FIGS. 2A, 3A, 5, 9A and 9B). The end surfaces may comprise any suitable geometry, including or in place of the ring shaped geometry shown in and described in reference to the figures. For example, any or all of a rectangular shape, polygonal shaped, triangular shaped, egg shaped, oval shaped, or other known spacer cross sectional geometry may be incorporated along the entire profile of spacer 102 or on each respective end to ensure the spacer comprises adequate surface area for mounting other elements of this disclosure and also comprises adequate strength, stiffness, rigidity, material mechanical compliance, or combinations thereof, for providing a spacer suitable for assembling and erecting one or more of the assemblies, or subassemblies, of this disclosure. In some embodiments, at least one pull latch may be utilized to fixedly attach at least one of the ring shaped end surfaces of each of spacer 102 to an end of one of antenna segments 104 (e.g., a top or bottom end of antenna segments 104). In some embodiments, the at least one pull latch comprises a plurality of pull latches (e.g., as shown in FIGS. 2A and 5). Additionally, or alternatively, one or more pull latches may be used to secure a bottom most of antenna segments 104 to a top surface of a base plate spacer integrated into, or fixedly attached to, antenna base 106. Each of spacers 102 and the base plate spacer of antenna base 106 may include at least one alignment feature that extends from, or is machined into or embedded into, a surface of a flange extending laterally away from ends of each of spacers 102 and the base plate spacer of antenna base 106 (e.g., as shown in FIGS. 2A, 5, 6A, 9A, and 9B). These alignment features are structured for locating the at least one pull latch before clamping the end of one of antenna segments 104 to the top surface of one or more of spacers 102 or the base plate spacer via the at least one pull latch. In some embodiments, the alignment feature is configured to interface with a clamp (e.g., as shown in FIGS. 7A and 7B).

FIG. 2A depicts antenna subassembly 200A that includes spacer 102 for coupling ends of antenna segments 104A and 104B (e.g., corresponding to antenna segments, or antennas, 104 of FIG. 1) to each other, in accordance with some embodiments of the disclosure. Antenna subassembly 200A may include, or incorporate, any or all of the elements showed in, or described in reference to FIGS. 1 and 2B-9B. Additionally, or alternatively, antenna subassembly 200A may be assembled using any, or all, of the elements of process 1000 of FIG. 10.

Antenna subassembly 200A is a coupling apparatus. The coupling apparatus depicted via antenna subassembly 200A includes spacer 102 (e.g., corresponding to spacers 102 of FIG. 1). Spacer 102 comprises first end 202A that is configured to interface with antenna segment 104A. Spacer 102 also comprises second end 202B that is configured to interface with antenna segment 104B. Between first end 202A and second end 202B is internal passageway 204. Internal passageway 204 extends from an end opening in first end 202A, that is covered by antenna segment 104A, to an end opening in second end 202B, that is covered by antenna segment 104B. In some embodiments, first end 202A does not include an end opening and the internal passageway ends at or near first end 202A. Internal passageway 204 also includes side opening 206 that is between first end 202A and second end 202B. As shown in FIG. 2A, at least one of first end 202A and second end 202B includes at least one of attachment features 214 for attaching ends of spacer 102 to either antenna segment 104A or 104B. Attachment features 214 may include one or more of fasteners, holes for receiving fasteners, pins, recesses for snap or press fitting pins, one or more areas for receiving bonding or adhesive material, or combinations thereof for enabling a quick attachment for mounting antenna segments to one or more spacers for creating an antenna assembly (e.g., antenna assembly 100 of FIG. 1).

Extending laterally away from first end 202A is flange 210A. Flange 210A is configured to interface with at least one of pull latches 212. As shown in FIG. 2A, a plurality of pull latches 212 are included. In some embodiments, at least one element of pull latches 212 are integrated into flange 210A. Additionally, or alternatively, flange 210A may comprise a cutout for receiving one or more bolts, or other securing or mounting features that are suitable for the available surface area of flange 210A, for mounting one or more of pull latch 212. For example, the feature may be at least one alignment feature comprising one or more of fasteners, holes for receiving fasteners, pins, recesses for snap or press fitting pins, one or more areas for receiving bonding or adhesive material, or combinations thereof for enabling a quick attachment. The features of flange 210A for interfacing pull latches 212 with flange 210A may be configured to align antenna segment 104A with an end of spacer 102. Extending laterally away from second end 202B is flange 210B. Flange 210B comprises one or more holes for receiving one or more of fasteners 214. In some embodiments, flange 210B may be bonded, or adhesively coupled to an end of antenna segment 104B. Arranged between second end 202B and antenna segment 104B is end cap 216. End cap 216 may be integrated into spacer 102 or may be fixedly attached via fasteners 214 to second end 202B and a top of antenna segment 104B. End cap 216 also comprises extensions 218 which each have a through hole for mounting a guy wire eyelet. End cap 216 may have one or more of extensions 218 equally spaced around an outer diameter of end cap 216 to enable even loads to be applied to antenna segment 104B to stabilize an antenna assembly that includes antenna subassembly 200A. Antenna segment 104B may considered a second antenna segment that is coupled to a second ring shaped end surface of spacer 102 and the second ring shaped end surface corresponds to an axial end of flange 202B.

Antenna subassembly 200A also comprises second side opening 208 arranged opposite side opening 206. Each of side opening 206 and second side opening 208 can be used to feed a cable that comprises a connector into internal passageway 204. The connector is configured to interface with, or be fixedly attached or coupled to, a complementary connector arranged on one or more of a bottom surface of antenna segment 104A or a top surface of antenna segment 104B.

FIG. 2B depicts antenna subassembly 200B incorporating multiple of antenna subassembly 200A of FIG. 2A, in accordance with some embodiments of the disclosure.

Antennas subassembly 200B may include, or incorporate, any or all of the elements showed in, or described in reference to FIGS. 1, 2A, and 3A9B. Additionally, or alternatively, antenna subassembly 200B may be assembled using any, or all, of the elements of process 1000 of FIG. 10.

Antenna subassembly 200B is considered a subassembly of antenna assembly 100 of FIG. 1 as antenna subassembly 200B lacks the guy wires that anchor and stabilize antenna assembly 100. Antenna subassembly 200B is shown incorporating at least one of antenna subassembly 200A. Three iterations of antenna subassembly 200A are shown arranged above antenna base 106 of FIG. 1.

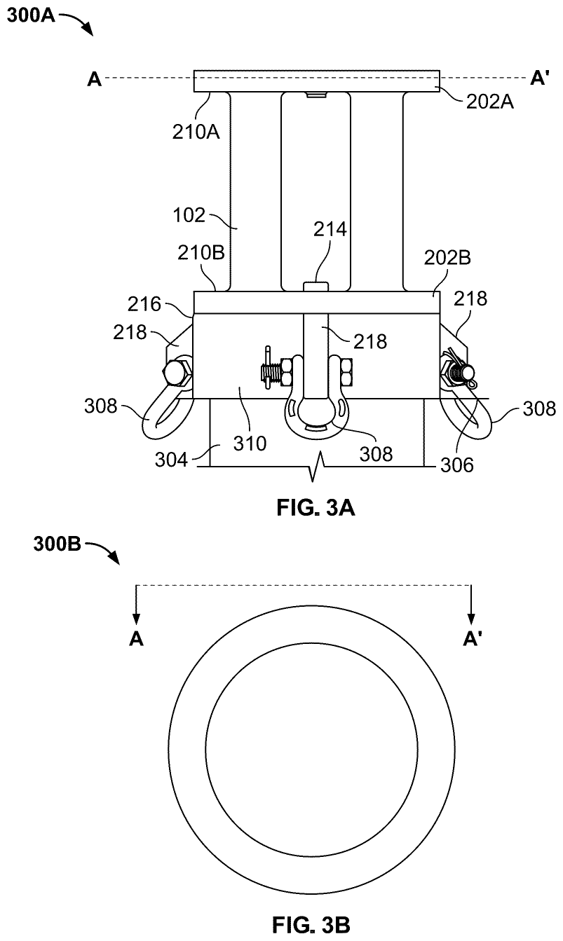

FIG. 3A depicts coupling apparatus 300A, in accordance with some embodiments of the disclosure Coupling apparatus 300A may include, or incorporate, any or all of the elements showed in, or described in reference to FIGS. 1-2B and 3B-9B. Additionally, or alternatively, coupling apparatus 300A may be assembled using any, or all, of the elements of process 1000 of FIG. 10.

Coupling apparatus 300A comprises spacer 102 and end cap 216. End cap 216 is fixedly attached to second end 202B of spacer 102. As shown in FIG. 3A, fastener 214 is used to affix second end 202B to a top of end cap 216. Additionally, or alternatively, end cap 216 may interface with second end 202B or may be affixed to second end 202B by threads, adhesive, bonding, or any other suitable form of coupling or affixing or fixedly attaching end cap 216 to second end 202B. Although not shown in FIG. 3A, first end 202A is arranged and configured to interface with, receive, be coupled to, to be affixed to an end of a first antenna. As shown in FIG. 3A, end cap 216 is configured to interface with second antenna 304, which corresponds to, for example, antenna segment 104B. Interface 306, which is arranged between end cap 216 and second antenna 304, may comprise a threaded interface, fasteners through threaded holes, snap features, adhesive, bonding, or any other suitable interface materials or structure for fixedly attaching or coupling end cap 216 to a top of second antenna 304 such that interface 306 is configured to withstand various loads experienced via coupling apparatus (e.g., as caused by loads applied to an antenna assembly comprised of at least one of coupling apparatus 300A which may be from guy wire securing loads, wind, weather conditions, or combinations thereof). Interface 306 is formed between flange 210B of second end 202B and end cap 216 as flange 210B of spacer 102 is configured to be fixedly attached to end cap 216 (e.g., via fastener 214).

End cap 216 also includes a plurality of evenly spaced eyelets 308, which can be characterized as ring shaped structures that are coupled to respective through holes that extend through a material thickness of extensions 218. Eyelets 308 may interface with, or be coupled to, respective through holes of respective extensions 218 by threaded fasteners, pinned rods, or any other suitable pivoting coupling mechanism. Eyelets 308 may be configured to rotate about a center axis defined by the respective through holes of each respective extension 218 to enable rapid and simple articulation of eyelets 308 when running guy wires for raising and securing an antenna assembly of this disclosure. Eyelets 308 are evenly spaced around radially outer surface 310 of end cap 216 and extend away from radially outer surface 310.

FIG. 3B depicts cross sectional view A-A′ of the coupling apparatus of FIG. 3A, in accordance with some embodiments of the disclosure. Cross sectional view A-A′ corresponds to axis A-A′ of FIG. 3A and depicts a ring shaped end surface of spacer 102. The ring shaped end surface may be present on one or more of axial end faces of first end 202A or second send 202B of spacer 102. One or more features (e.g., holes, pins, threaded interface, or combinations thereof) may be present on end surfaces of a spacer end defined via cross sectional view A-A′.

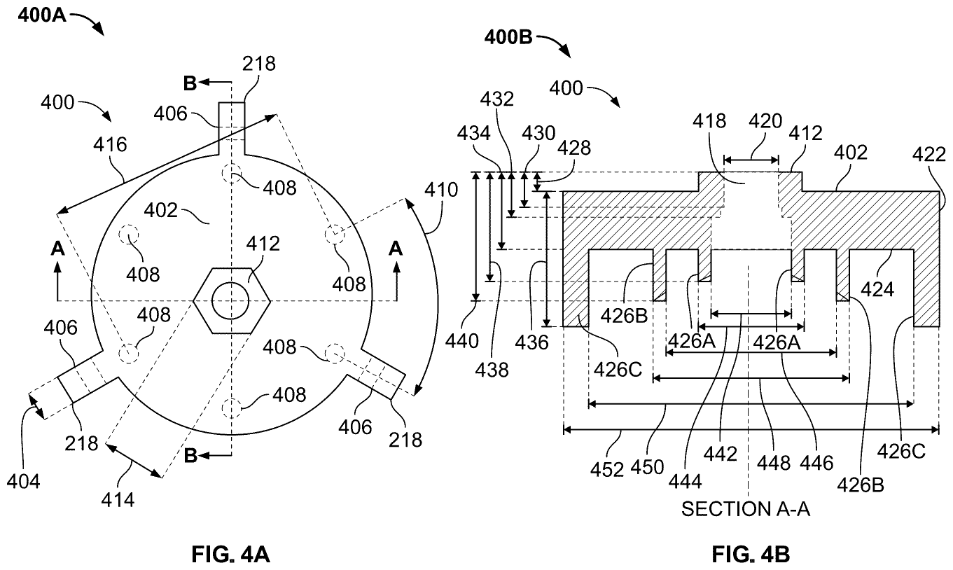

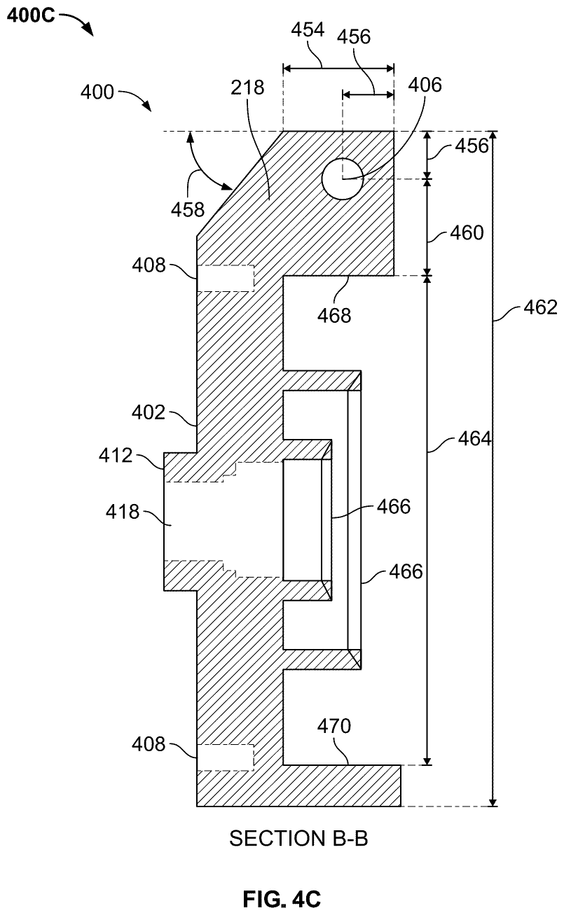

FIG. 4A depicts top view 400A of end cap 400 of a coupling apparatus, in accordance with some embodiments of the disclosure. End cap 400 may include, or incorporate, any or all of the elements showed in, or described in reference to FIGS. 1-3B and 4B-9B. Additionally, or alternatively, end cap 400 may be incorporated into any or all of the elements of process 1000 of FIG. 10. Any or all corners, edges, or interfaces between features (e.g., between a flange and a radially outer surface of an end cap body) may include one or more of a rounded radius, a chamfer, or other machined feature to reduce stress at corners, edges, or interfaces.

End cap 400 corresponds to end cap 216 of FIGS. 2 and 3A. End cap 400 is comprised of extensions 218 and mating surface 402. Each of extensions 218 has a width 404. Width 404 may be 0.5 inches up to 1.5 inches. Each of extensions 218 includes a respective through feature 406. Each of through features 406 may be utilized to mount eyelets 308 of FIG. 3A, for example, to provide a path for feeding guy wires or other cables that would be part of an antenna assembly comprised of end cap 400. Evenly spaced around surface 402 are openings 408. Each of openings 408 may be one or more of a through hole, a threaded hole, a recess, a blind hole, or an accommodating feature. Openings 408 may, for example, be used to receive fasteners for securing a flange of a spacer of this disclosure to surface 402. Each of openings 408 may be an eight of an inch in diameter up to 1 inch in diameter (e.g., depending on a width of a flange of a spacer to be secured to surface 402). As shown in FIG. 4A, openings 408 are spaced 60 degrees apart, as represented by spacing 410. Spacing 410 may be adjusted such that each of openings 408 are evening spaced around surface 308. For example, although six of openings 408 are shown in FIG. 4A, in some embodiments there may only be four of openings 408 and spacing 410 may increase from 60 degrees to 90 degrees. Spacing 410 is a function of the number of openings 408 present on surface 408 such that each of openings 408 are evenly spaced around surface 402 to ensure a levelled or even securing interface between a flange of a spacer of this disclosure and surface 402 (e.g., capable of withstanding environmental conditions in a remote location where an antenna assembly of this disclosure is assembled and erected, or capable of withstanding an assembly and raising process of an antenna assembly of this disclosure). Each of openings may be displaced from each other along width 416. Width 416 may be between 4 inches and 10 inches, depending on a diameter of antennas or antenna segments that are to be coupled to a surface of end cap 400 and a width of a flange of a spacer of this disclosure.

End cap 400 includes raised feature 412. Raised feature 412 is centered on surface 402. As shown in FIG. 4A, raised feature 412 is of a hexagonal shape. In some embodiments, raised feature 412 may be any suitable shape to enable appropriate function of raised feature 412. Raised feature 412 may comprise one or more of a recess, a through hole, a blind hole, or a threaded hole to enable securing (e.g., preferably in rapid fashion) end cap 400 to an end of an antenna or antenna segment. For example, a fastener may be fed into the opening or hole in the center of raised feature 412 and raised feature 412 may be used to apply a rotational torque to a body of end cap 400 to enable securing of end cap 400 to a component below end cap 400 (e.g., a top of an antenna or antenna segment). Raised feature 412 has width 414. Width 414 may be from 1 inch up to 2.5 inches (e.g., from flat to flat of a hexagonal geometry), depending on how much torque is to be applied to raised feature 412 to secure end cap 400 to a top of an antenna segment.

FIG. 4B depicts side cross sectional view 400B along A-A of FIG. 4A of end cap 400, in accordance with some embodiments of the disclosure. End cap 400 may include, or incorporate, any or all of the elements showed in, or described in reference to FIGS. 1-4A and 4C-9B. Additionally, or alternatively, end cap 400 may be incorporated in any or all of the elements of process 1000 of FIG. 10. Any or all corners, edges, or interfaces between features (e.g., between a flange and a radially outer surface of an end cap body) may include one or more of a rounded radius, a chamfer, or other machined feature to reduce stress at corners, edges, or interfaces.

View 400B depicts end cap 400 along cross section A-A. Raised feature 412 is shown with through feature 418. Width 420 of through feature 418 may be 0.5 inches up to 1.5 inches, depending on what kind of fastener, or securing element, is used to secure end cap 400 to a top of an antenna segment. As shown in FIG. 4B, through feature 418 is comprised of a profile that expands radially outwards towards radially outer surface 422 of end cap 400 as through feature 418 extends from a top of raised feature 412 to bottom surface 424 of end cap 400. Radially outer surface 422 includes height 436. Heigh 436 may be between 2 inches and 4 inches, depending on spacing requirements between respective antenna segments and a size of a spacer affixed to surface 402. Raised feature 412 has height 428 above surface 402. Height 428 may be between 0.25 inches and 1 inch, depending on a size and shape of a spacer affixed to surface 402. A first portion of through feature 418 has height 430. Height 430 may be between 0.4 inches and 1 inch, depending on the size and shape of features of a top of an antenna segment to be secured to a bottom area of end cap 402 comprising ring extensions 426A-C.

As shown in FIG. 4B, through feature 418 expands radially outward at height 430 and again at height 432, remaining consistent until height 434. Height 432 may be between 0.1 inches and 0.5 inches. Height 434 may be between 0.4 inches and 0.8 inches. In some embodiments, a first portion of material of end cap 400 extends between ends of ring extensions 426A. Second portions of material may extend between ends of ring extensions 426B. Third portions of material may also extend between ends of ring extensions 426C (e.g., as shown in FIG. 4C). Ring extensions 426A include height 438. Height 438 may be between 1 inch and 1.5 inches. Ring extensions 426B include height 440. Height 440 may be between 2 inches and 3 inches. Ring extensions 426C comprise height 436 of radially outer surface 422. Inner diameter 442 of ring extensions 426A may between 1.4 inches and 1.7 inches. Outer diameter 444 of ring extensions 426A may be between 1.8 inches and 2.2 inches. Inner diameter 446 of ring extensions 426B may be between 3 inches and 3.5 inches. Outer diameter 448 of ring extensions 426B may be between 3.55 inches and 3.8 inches. Inner diameter 450 of ring extensions 426C may be between 5.5 inches and 6.5 inches. Outer diameter 452 of ring extensions 426C may be between 6.8 inches and 7.5 inches. The geometry and spacing of each of ring extensions 426A-C may be modified from the above dimensions depending on features, geometry, and dimensions of a top surface of an antenna or antenna segment to which end cap 400 is affixed as a part of an antenna assembly of this disclosure.

FIG. 4C depicts side cross sectional view 400C along B-B of FIG. 4A of end cap 400, in accordance with some embodiments of the disclosure. End cap 400 may include, or incorporate, any or all of the elements showed in, or described in reference to FIGS. 1-4B and 5-9B. Additionally, or alternatively, end cap 400 may be incorporated into any or all of the elements of process 1000 of FIG. 10. Any or all corners, edges, or interfaces between features (e.g., between a flange and a radially outer surface of an end cap body) may include one or more of a rounded radius, a chamfer, or other machined feature to reduce stress at corners, edges, or interfaces.

Cross sectional view 400C depicts one of flanges 218, based on the arrangement of B-B in FIG. 4A. Flange 218 includes through feature 406. Through feature 406 is arranged towards a radially outer corner of flange 218 and may be between 0.3 inches and 0.8 inches in diameter, depending on the sized guy wire eyelets required for an antenna assembly comprised of end cap 400. Through feature 406 is displaced from a radially outer edge of flange 218 by measurement 456 and is also displaced from an axial bottom edge of flange 218 by measurement 456. Measurement 456 may be between 0.5 and 1 inch, depending on a size of flange 218 in order to center through feature 406 relative to a radially outer and axially lower corner of flange 218. Flange 218 is shown in FIG. 4C has having axially upper corner modified to not have material in angle 458. Angle 458 may be between 0 degrees and 90 degrees. In some embodiments, flange 218 is rectangular or square in profile. In other embodiments, flange 218 may comprise any suitable rounded profile for supporting loads corresponding to a guy wire or a guy wire eyelet for securing an antenna assembly comprised of end cap 400. Angle 458 is shown as starting from a corner at height 454 of a radially outer edge of flange 218. Height 454 may be between 0.8 inches and 2 inches.

Through feature 406 is radially displaced from flange inner surface 468. Distance 460 between a center of through feature 406 and flange inner surface 468 may be between 0.5 inches and 1.5 inches. Distance 464 between flange inner surface 468 and ring extension inner surface 470 may be between 5.5 inches and 7 inches. Along section B-B, width 462 of end cap 400 may be between 6.5 inches and 10 inches, depending on tolerance stacks of the other dimensions of FIG. 4C and geometry of an interfacing surface of an antenna segment on which end cap 400 is to be mounted. Arranged between flange inner surface 468 and ring extension inner surface 470 are connecting rings 466. Connecting rings 466 connect axial ends of ring extensions 426A and 426B of FIG. 4B.

FIG. 5 depicts antenna subassembly 500 which includes spacer 102 between antenna 502 and antenna 504 with accessory platform 506, in accordance with some embodiments of the disclosure. Antenna subassembly 500 may include, or incorporate, any or all of the elements showed in, or described in reference to FIGS. 1-4B and 6A-9B. Additionally, or alternatively, antenna subassembly 500 may be assembled using any, or all, of the elements of process 1000 of FIG. 10.

Antenna subassembly 500 may be utilized as part of or in replacement of antenna subassembly 200A of FIG. 2A (e.g., as part of antenna assembly 100 of FIG. 1 or antenna subassembly 200B of FIG. 2B). Antenna subassembly 500 comprises antenna 502, which is directly coupled to first end 202A of spacer 102 via pull latches 212. Second end 202B of spacer 102 is shown on top of accessory platform 506, which is in direct contact with a top end of end cap 216. Fasteners 214 extend through flange 210B and through accessory platform 506 into end cap 216. In some embodiments, fasteners 214 may also extend into antenna 504. As shown in FIG. 5, accessory platform 506 is arranged between spacer 102 and end cap 216. Additionally, or alternatively, accessory platform 506, or additional iterations of accessory platform 506, may be arranged between any two components depicted in FIG. 5. Accessory platform 506 as shown in FIG. 5 supports tilt sensors 508, which are configured to determine whether antenna subassembly 500, or an antenna assembly comprised of one or more of antenna subassembly, is tilting about one or more axes extending from accessory platform 506, or axes defined by multiple installations of accessory platform 506 up and down an antenna assembly comprised of multiple installments of antenna subassembly 500. In some embodiments, accessory platform 506 may be utilized to hold one or more of tools, cables, or subcomponents pertinent to maintenance, assembly, or raising of an antenna assembly comprised of antenna subassembly 500. Coupled to, affixed to, or arranged on radially outward surfaces of antenna 502 and antenna 504 are cable securing features 510. Cable securing features 510 comprise any suitable dimension, configuration, or combination of components for fixedly attaching portions of cables that create channels of communication and/or provide power to different elements of an antenna assembly comprised of one or more iterations of antenna subassembly 500.

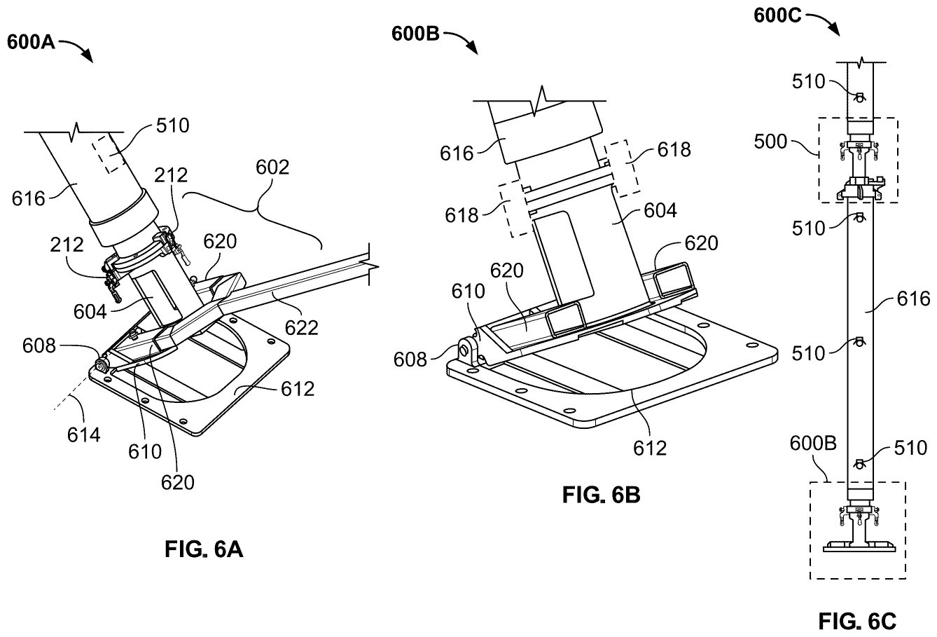

FIG. 6A depicts antenna base 602 interfacing with gin pole 604 as part of antenna subassembly 600A, in accordance with some embodiments of the disclosure. Antenna base 602 may include, or incorporate, any or all of the elements showed in, or described in reference to FIGS. 1-5 and 6B-9B. Additionally, or alternatively, antenna base 602 may be assembled using any, or all, of the elements of process 1000 of FIG. 10.

Antenna base 602 is comprised of base spacer 604. Base spacer 604 may be mounted to or incorporated into (e.g., comprising material of) antenna base 602. Antenna base 602 is comprised of hinge assembly 608, pivotable base plate surface 610, and securing platform 612. Pivotable surface 610, from which base spacer 604 extends, is coupled to securing platform 612 via hinge assembly 608. Accordingly, base spacer 604 is pivotably attached to securing platform 612 (e.g., a base plate). Hinge assembly 608 defines hinge axis 614 for rotating base spacer 604 relative to securing platform 612 by articulation of pivotable base plate surface 610. Antenna segment 616 is fixedly attached to base spacer 604 via pull latches 212. Antenna segment 616 also includes at least one of cable securing features 510. Slots 620 are coupled to base spacer 604 along pivotable surface 610. As shown in FIG. 6A, there is a pair of slots 620. In some embodiments, there may only be one of slots 620 or there may be more than two of slots 620. Slots 620 each extend radially outward from hinge axis 614 of hinge assembly 608 towards a radially outward edge of pivotable surface 610. Slots 620 receive a forked end of gin pole 622. Gin pole 622 is used to pivot base spacer 604 and pivotable surface 610 relative to securing platform 612, which is configured to be fixedly attached to a surface (e.g., ground of a remote location). In some embodiments, base spacer 604 is not pivotably actuatable relative to securing platform 612. Additionally, or alternatively, base spacer 604 may be directly affixed to or extending from a top surface of securing platform 612. In some embodiments, there may be one or more attachment features on antenna base 602 for attaching or storing gin pole 622 when gin pole 622 is not in use (e.g., interfacing with one or more of slots 620 for raising an antenna assembly comprising antenna base 602 into a vertical orientation). In some embodiments, gin pole 622 is not required to pivot base spacer 604 relative to securing platform 612.

Base spacer 604 may incorporate or be comprised of any or all of the elements of spacer 102. For example, base spacer 604 may comprise at least one flange that includes at least one alignment feature for locating at least one of pull latches 212 before clamping the end of antenna segment 616 to the top surface of base spacer 604 via at least one of pull latches 212. For example, a flange may comprise a top surface of base spacer 604. Each of pull latches 212 is fixedly attached to the flange. Each of pull latches 212 interfaces with a respective alignment feature of a flange of antenna segment 616.

FIG. 6B depicts, via view 600B, base plate spacer 604 of antenna base 602 of FIG. 6A pivoting via hinge assembly 608, in accordance with some embodiments of the disclosure. View 600B depicts antenna base 602 without gin pole 622 interfacing with each of slots 620. Clamping apparatus 618 may incorporate one or more of pull latches 212 or clamp assembly 700A of FIG. 7A to secure antenna segment 616 to a top flange or ring shaped surface of base spacer 604.

FIG. 6C depicts, via view 600C, antenna base 602 of FIGS. 6A and 6B coupled at a bottom of antenna subassembly 600C, in accordance with some embodiments of the disclosure. Antenna subassembly 600C may include, or incorporate, any or all of the elements showed in, or described in reference to FIGS. 1-6B and 7A-9B. Additionally, or alternatively, antenna subassembly 600C may be assembled using any, or all, of the elements of process 1000 of FIG. 10. Antenna subassembly 700C includes view 600B of antenna base 602, which includes clamping apparatus 618. Clamping apparatus 618 may include at least one of pull latches 212 that fixedly attaches an end of antenna segment 616 to a top surface of base spacer 604. Arranged above antenna segment 616 is antenna subassembly 500 of FIG. 5. There are also a plurality of cable securing features 510 arranged along a radially outer surface of antenna segments of antenna subassembly 600C.

FIG. 7A depicts cross sectional side view 700A of clamp assembly 702 that interfaces with spacer 102 and antenna 104A, in accordance with some embodiments of the disclosure. Clamp assembly 702 may include, or incorporate, any or all of the elements showed in, or described in reference to FIGS. 1-6C and 7B-9B. Additionally, or alternatively, clamp assembly 702 may be utilized as part of any, or all, of the elements of process 1000 of FIG. 10.

Clamp assembly 702 includes opening 704. Within opening 704 are tapered inner surfaces 706A and 706B, which narrow from opening 704 towards clamp rear 718. The taper of these surfaces are exaggerated for illustrative purposes in FIG. 7A. Any suitable taper for achieving the described clamping affect would be suitable for this embodiment. Clamp assembly 702 may be used instead of pull latch assemblies 212. Inner surface 706A interfaces with flange 708 of antenna segment 710. Flange 708 includes alignment feature accommodation 712, which receives alignment feature 714. Alignment feature 714 extends from top flange 716 of base spacer 604 and provides a means to align flange 708 of antenna segment 710 with top flange 716 of base spacer 604.

FIG. 7B depicts perspective view 700B of clamp assembly 702 of FIG. 7A interfacing with base plate spacer 604 and antenna segment 710, in accordance with some embodiments of the disclosure. Clamp assembly 702 comprises hinge 720. Hinge 720 rotatably couples first arched arm 722 to second arched arm 724. Each of first arched arm 722 and second arched arm 724 comprise channel 726 (e.g., corresponding to opening 704, inner surfaces 706A and 706B, and clamp rear 718) that is accommodates flange 716 of base spacer 604 and flange 708 of antenna segment 710. In some embodiments, channel 726 accommodates a flange of spacer 102 of FIG. 1 in addition to flange 708 of antenna segment 710. Channel 726 comprises a width corresponding to opening 704 that narrows (e.g., based on a profile of inner surfaces 706A and 706B) towards a bottom of channel 726 (e.g., as defined by clamp rear 718). Clamp assembly 702 also includes adjustable handle 728. Adjustable handle 728 increases a clamping force between an end of first arched arm 722 and an end of second arched arm 724 as clamp assembly 702 encompasses flange 716 and flange 708. Alignment feature 714 interfaces with flange 708 to align antenna segment 710 with a ring shaped surface of flange 716 of base spacer 604. Base spacer 604 extends from antenna base 602. Clamp assembly 702 may be utilized in any or all antenna assemblies or subassemblies of this disclosure as an alternative securing means between spacers, antennas, or antenna segments to the pull latches described herein.

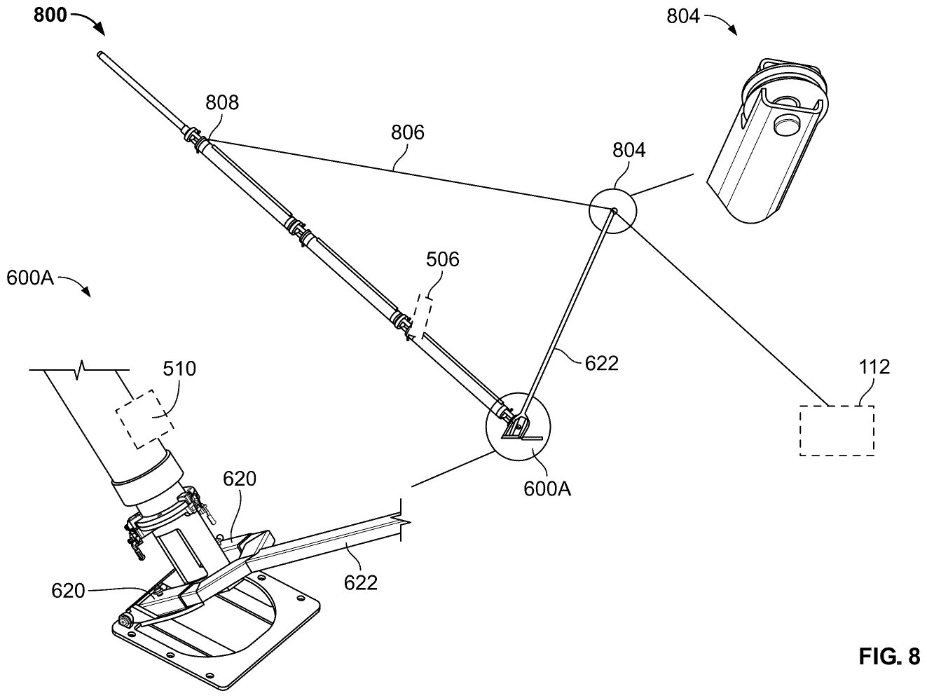

FIG. 8 depicts a manner of erecting antenna assembly 800, in accordance with some embodiments of the disclosure. Antenna assembly 100 may include, or incorporate, any or all of the elements showed in, or described in reference to FIGS. 2A-7B and 9A-9B. Additionally, or alternatively, antenna assembly 100 may be assembled using any, or all, of the elements of process 1000 of FIG. 10.

As shown in FIG. 8, antenna subassembly 600A is arranged at the base of antenna assembly 800 to enable antenna assembly 800 to be raised from a horizontal orientation towards a vertical orientation. Gin pole 622 is inserted into slots 620 and provides a leverage point. Gin pole 622 also comprises guy wire wheel 804 for running guy wire 806 from antenna coupling interface 808 to guy wire anchor 112. In some embodiments, guy wire anchor 112 may include a motorized apparatus for retracting guy wire 806 to pull a distal end of antenna assembly 800 such that antenna assembly 800 is moved from a horizontal (e.g., laid down) orientation to a vertical orientation. Antenna assembly 800 also includes accessory platform 506, which may incorporate one or more tilt sensors to indicate when antenna assembly 800 is in a vertical orientation. In some embodiments, an actuator at guy wire anchor 112 may be configured to stop pulling guy wire 806 when a tilt sensor of accessory platform 506 provides data indicating antenna assembly 800 is in a vertical orientation.

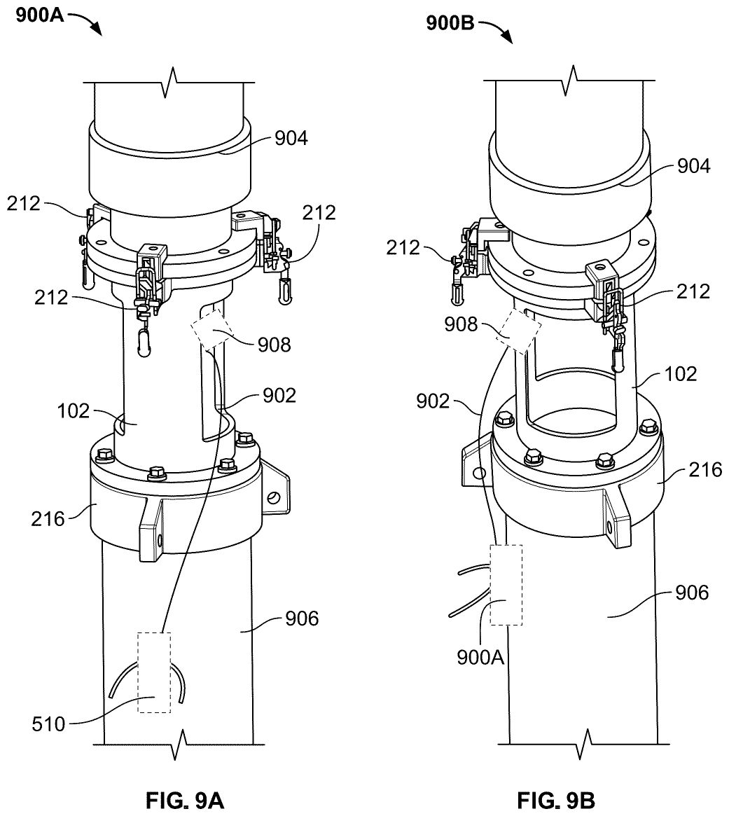

FIG. 9A depicts first perspective view 900A of routing cable 902 into spacer 102 towards antenna 904 coupled to spacer 102, in accordance with some embodiments of the disclosure. First perspective view 900A may include, or incorporate, any or all of the elements showed in, or described in reference to FIGS. 1-8 and 9B. Additionally, or alternatively, first perspective view 900A depicts a subassembly may be assembled using any, or all, of the elements of process 1000 of FIG. 10.

First perspective view 900A shows antenna 904 coupled to a top of spacer 102. Pull latch assemblies 212 couple antenna 904 to the top of spacer 102. A bottom end of spacer 102 is fixedly attached to end cap 216, which is affixed to a top of antenna 906. Using cable securing feature 510, cable 902 is coupled to a radially outer surface of antenna 906. Cable 902 may be considered a wire. Cable 902 is fed through a side opening of spacer 102 and into a passageway of spacer 102. Connector 908 is on an end of cable 902. Connector 908 is secured to a complementary connector on an exposed surface of antenna 904, for example, a bottom surface accessible via the passageway of spacer 102. Cable 902 extends out of the side opening of spacer 102 and along the radially outer surface of antenna 906 towards the base of antenna 904, which is stacked on, or affixed to, a top of spacer 102. Cable 902 may be fed from a ground cable or wire source, and snaked up an antenna assembly, making connections via connector 908 and being secured to an outer surface via a plurality of cable securing features 510.

FIG. 9B depicts second perspective view 900B of routing a cable into a spacer towards an antenna coupled to the spacer, in accordance with some embodiments of the disclosure. Second perspective view 900B may include, or incorporate, any or all of the elements showed in, or described in reference to FIGS. 1-9A. Additionally, or alternatively, second perspective view 900B depicts a subassembly may be assembled using any, or all, of the elements of process 1000 of FIG. 10.

FIG. 10 is a flow chart representing process 1000 for assembling an antenna assembly, in accordance with some embodiments of the disclosure. Process 1000 may utilize, or incorporate, any or all of the elements, or components, depicted in or described in reference to FIGS. 1-9B. An antenna assembly assembled using any or all elements of process 1000 may incorporate, or be incorporated into, any or all of the elements shown in, or described in reference to FIGS. 1-9B.

At process block 1002, a bottom end of a first antenna segment is secured to a base spacer of a base plate. For example, clamp assembly 702 or pull latches 212 may be utilized. At process block 1004, a top end of the first antenna segment is coupled to a first end of a spacer.

At process block 706, a bottom end of a second antenna segment is fixedly attached to a second end of the spacer with at least one pull latch. At process block 1008, a wire is fed through a side opening of the spacer and into a passageway of the spacer. At process block 1010, a connector of the wire is secured to a complementary connector on an exposed bottom surface of the second antenna segment. At process block 1012, a first end of at least one guy wire is secured to at least one guy wire eyelet of a coupling apparatus comprising the spacer. At process block 1014, a distal second end of the at least one guy wire is fixedly attached to a grounded anchoring apparatus.

The assemblies, apparatuses, systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the methods described herein may be performed in real time. It should also be noted that the assemblies, apparatuses, systems and/or methods described above may be applied to, or used in accordance with, other assemblies, apparatuses, systems and/or methods.

What is claimed is:

1. A coupling apparatus comprising:
a spacer comprising:
a first end configured to interface with a first antenna,
a second end configured to interface with a second antenna, and
an internal passageway extending from an end opening in the first end and a side opening between the first end and the second end.

2. The coupling apparatus of claim 1, further comprising an end cap fixedly attached to the second end of the spacer, wherein the second end of the spacer is configured to interface with the second antenna via the end cap.

3. The coupling apparatus of claim 2, wherein the spacer comprises a flange configured to be fixedly attached to the end cap.

4. The coupling apparatus of claim 2, wherein the end cap comprises a plurality of evenly spaced eyelets that extend away from a radially outer surface of the end cap.

5. The coupling apparatus of claim 2, further comprising an accessory platform arranged between the spacer and the end cap.

6. The coupling apparatus of claim 1, wherein at least one of the first end or the second end comprises at least one feature for fixedly attaching the spacer to either the first antenna or the second antenna.

7. The coupling apparatus of claim 1, wherein the side opening is a first side opening and the spacer further comprises a second side opening arranged opposite of the first side opening.

8. The coupling apparatus of claim 1, wherein the first end comprises a flange configured to interface with one or more pull latches.

9. The coupling apparatus of claim 1, wherein:
when the first antenna is coupled to the first end, a cable that a comprises a connector passes through the internal passageway from the side opening and towards a complementary connector on a surface of the first antenna; and
the connector is coupled to the complementary connector.

10. An antenna assembly comprising:
a spacer having a first ring shaped end surface and an internal passageway extending between an opening in the first ring shaped end surface and a side opening between the first ring shaped end surface and a second ring shaped end surface;
a first antenna segment fixedly attached to the first ring shaped surface of the spacer, wherein a cable comprising a connector passes through the internal passageway from the side opening and towards a complementary connector on a surface of the first antenna segment; and
a second antenna segment coupled to the second ring shaped end surface of the spacer.

11. The antenna assembly of claim 10, further comprising an antenna base comprising a base spacer pivotably attached to a base plate.

12. The antenna assembly of claim 11, wherein the antenna base comprises a hinge assembly defining a hinge axis for rotating the base spacer.

13. The antenna assembly of claim 12, further comprising:
a pair of slots coupled to the base spacer; and
each of the pair of slots extends radially outward from the hinge axis.

14. The antenna assembly of claim 11, further comprising at least one pull latch that fixedly attaches an end of the second antenna segment to a top surface of the base spacer.

15. The antenna assembly of claim 14, wherein a flange of the base spacer comprises at least one alignment feature for locating the at least one pull latch before clamping the end of the second antenna segment to the top surface of the base spacer via the at least one pull latch.

16. The antenna assembly of claim 14, wherein the at least one pull latch comprises a plurality of pull latches.

17. The antenna assembly of claim 16, wherein:
a flange comprises the top surface of the base spacer;
each pull latch of the plurality of pull latches is fixedly attached to the flange; and
each pull latch of the plurality of pull latches interfaces with a respective alignment feature of a flange of an antenna segment.

18. The antenna assembly of claim 11, further comprising a clamp assembly, the clamp assembly comprising:
a hinge rotatably coupling a first arched arm to a second arched arm, wherein:
each of the first arched arm and second arched arm comprise a channel that is configured to accommodate a flange of the spacer and a flange of one of the first antenna segment and the second antenna segment, and
the channel comprises a width that narrows towards a bottom of the channel; and
an adjustable handle for increasing a clamping force between an end of the first arched arm and an end of the second arched arm.

19. A method of assembling an antenna assembly, the method comprising:
securing a bottom end of a first antenna segment to a base spacer of a base plate;
coupling a top end of the first antenna segment to a first end of a spacer; and
fixedly attaching a bottom end of a second antenna segment to a second end of the spacer with at least one pull latch.

20. The method of claim 19, further comprising:
feeding a wire through a side opening of the spacer and into a passageway of the spacer;
securing a connector of the wire to a complementary connector on an exposed bottom surface of the second antenna segment;
securing a first end of at least one guy wire to at least one guy wire eyelet of a coupling apparatus comprising the spacer; and
fixedly attaching a distal second end of the at least one guy wire to a grounded anchoring apparatus.
